(19) United States
(12) Patent Application Publication
(10) Pub. No.: US 2016/0140190 A1
(43) Pub. Date: May 19, 2016

(54) DATA REPRESENTATION

(71) Applicant: Spatial Information Systems Research Limited, Carlton (AU)

(72) Inventor: Simon Paul MONCRIEFF, Wilson (AU)

(21) Appl. No.: 14/931,150

(22) Filed: Nov. 3, 2015

Related U.S. Application Data
(60) Provisional application No. 62/074,970, filed on Nov. 4, 2014.

(51) Int. Cl. G06F 17/30

(52) U.S. Cl. CPC G06F 17/30554; G06F 17/30395; G06F 17/30867

(57) ABSTRACT

Apparatus for generating a representation of data in a dataset, the apparatus including one or more processing devices that receive a search request including an indication of parameter values from a client device via a communications network, generate a query using the parameter values, apply the query to one or more datasets to obtain retrieved data, process the retrieved data to generate results data compliant with one or more criteria, generate a representation of the results data and provide the representation of the results data to the client device via the communications network.

### BACKGROUND OF THE INVENTION

The present invention relates to a method and apparatus for generating a representation of data in a dataset, and in one particular example to generating a representation of data compliant with one or more criteria, such as privacy requirements.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Creation and analysis of large datasets is becoming more prevalent as larger amounts of data are collected through various data collections mechanisms. The ability to analyse and interpret meaning within the data is problematic, meaning that data is often analysed using complex statistical techniques. Even so, data can be hard to understand and the creation of data representations can significantly assist in this regard.

A further issue is that of privacy associated with data, particularly when collected data relates to entities such as individuals. For example, analysis of demographic and health related data can lead to disclosure of information relating individuals that would breach privacy requirements. This problem is further exacerbated by the fact that health datasets can be large and complex, with the data being distributed amongst a number of data custodians, with restricted and resolution dependent access to data often being enforced.

U.S. Pat. No. 8,326,849 describes a method, system and computer memory for optimally de-identifying a dataset. The dataset is obtained from a storage device and equivalence classes within the dataset are determined A lattice is determined defining anonymization strategies, a solution set for the lattice is generated and an optimal node from the solution set is determined, allowing the dataset to be de-identified using the generalization defined by the optimal node.

Accordingly, in approaches such as this, custodians of the dataset will typically perform an analysis to create a generalised de-identified dataset, allowing this to be made available for subsequent analysis. This data is no longer “live” and consequentially is out of date almost as soon as it is created. Additionally, the data is typically anonymised based on a worst case scenario approach to allow the data to remain anonymised using a range of different types of analysis, meaning that much valuable information is lost.

### SUMMARY OF THE PRESENT INVENTION

In one broad form the present invention seeks to provide apparatus for generating a representation of data in a dataset, the apparatus including one or more processing devices that:
a) receive a search request including an indication of parameter values from a client device via a communications network;
b) generate a query using the parameter values;
c) apply the query to one or more datasets to obtain retrieved data;
d) process the retrieved data to generate results data compliant with one or more criteria;
e) generate a representation of the results data; and,
f) provide the representation of the results data to the client device via the communications network.

Typically the one or more processing devices:
a) compare the retrieved data to the one or more criteria; and,
b) if the one or more criteria are not satisfied, at least one of:
   i) selectively process the retrieved data in accordance with the results of the comparison; and,
   ii) generate a revised query to obtained alternative retrieved data.

Typically the one or more processing devices, process the retrieved data by filtering the retrieved data.

Typically the one or more processing devices progressively filter the retrieved data until the one or more criteria are satisfied.

Typically the one or more processing devices process the retrieved data by aggregating the data.

Typically the one or more processing devices process the retrieved data at least partially at least one of:
a) in accordance with user input commands;
b) using filter parameters;
c) using processing parameters; and,
d) spatially.

Typically the one or more criteria include privacy criteria.

Typically the one or more processing devices:
a) create a data store; and,
b) store the retrieved data in the data store.

Typically the one or more processing devices merge retrieved data at least one of:
a) from a number of datasets; and,
b) in a data store.

Typically the parameters include at least one of:
a) global parameters independent of the datasets, the global parameters being used in processing and presentation of the results data;
b) filter parameters related to the dataset, the filter parameters being used in filtering data to generate results data;
c) processing parameters, the processing parameters being used in processing the retrieved data; and,
d) spatial parameters, the spatial parameters being used in generating a spatial representation of the results data.

Typically the filter parameters include at least one of:
a) attribute parameters directly mapped to parameters of the at least one dataset;
b) virtual parameters indirectly mapped to parameters of the at least one dataset; and,
c) logical parameters that are used in controlling processing of the attribute parameters.

Typically the one or more processing devices:
a) determine one or more selected datasets;
b) identify parameters associated with the selected datasets; and,
c) provide an indication of available parameters to a client device via a communications network.

Typically the one or more processing devices:
a) provide a list of available datasets to the client device via the communications network; and,
b) receive an indication of a user selection of one or more available datasets via the communications network.

Typically the one or more processing devices:
a) perform a statistical analysis; and,
b) provide results of the statistical analysis with the results data.

Typically the representation includes at least one of:
a) a geospatial representation; and,
b) a layer for display as part of a geospatial representation.

Typically the representation includes:
a) a number of regions; and,
b) indicators at least partially indicative of results data associated with each region.

Typically the results data includes ranges of values for each region.

Typically the one or more processing devices process the retrieved data by aggregating retrieved data for different regions.

Typically the one or more processing devices:
a) provide the representation to the client device;
b) receive an indication of modified parameter values from the client device;
c) use the modified parameter values to determine a modified representation; and,
d) providing the modified representation to the client device.

In another broad form the present invention seeks to provide a method for generating a representation of data in a dataset, the method including in one or more processing devices:
a) receiving a search request including an indication of parameter values from a client device via the communications network;
b) generating a query using the parameter values;
c) applying the query to one or more datasets to obtain retrieved data;
d) processing the retrieved data to generate results data compliant with one or more criteria;
e) generating a representation of the results data; and,
f) providing the representation of the results data to the client device via the communications network.

It will be appreciated that the broad forms of the invention can be used independently or in conjunction, depending on the preferred implementation and that features of the method can be performed by the method and vice versa.

### BRIEF DESCRIPTION OF THE DRAWINGS

An example of the present invention will now be described with reference to the accompanying drawings, in which:

FIG. 1 is a flowchart of an example of a method for generating a representation of data in a dataset;

FIG. 2 is a schematic diagram of an example of a distributed computer architecture;

FIG. 3 is a schematic diagram of an example of a processing system of FIG. 2;

FIG. 4 is a schematic diagram of an example of a client device of FIG. 2;

FIGS. 5A and 5B are a flowchart of a second example of a method for generating a representation of data in a dataset;

FIG. 6 is a schematic diagram of an example of a workflow overview;

FIG. 7A is a schematic diagram of a specific example of an apparatus for generating a representation of data in a dataset;

FIG. 7B is a schematic diagram of an example of the workflow of the apparatus of FIG. 7A;

FIGS. 8A to 8D are schematic diagrams of examples of user interfaces for selecting parameter values;

FIGS. 9A to 9J are schematic diagrams of examples of user interfaces for displaying representations associated with different parameter values;

FIG. 10A is a graph showing a comparison of privacy compared to a traditional privacy approach; and,

FIG. 10B is a graph showing a coverage resulting from statistical reliability.

### DETAILED DESCRIPTION OF THE PREFERRED EMBODIMENTS

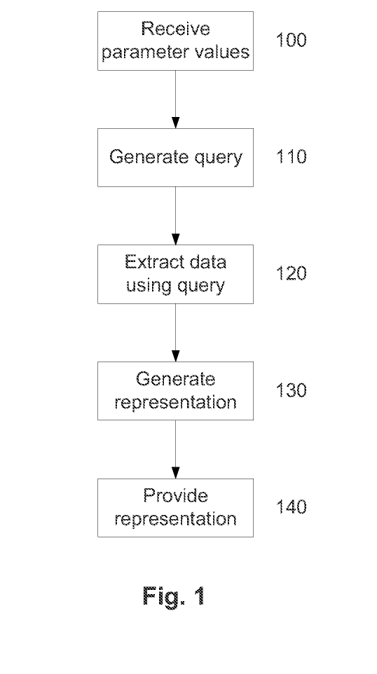

An example of a method for generating a representation of data in a dataset will now be described with reference to FIG. 1.

For the purpose of illustration, it is assumed that the process is performed at least in part using one or more electronic processing devices forming part of one or more processing systems, such as servers, which are in turn connected to one or more client devices via a network architecture, as will be described in more detail below.

In this example, at step 100, the one or more processing devices receive a search request including an indication of parameter values from a client device via the communications network. The parameter values can be of any appropriate form and typically at least in part specify the nature of data within the dataset that is of particular interest. The parameter values can be specific to particular datasets, or could be generic parameters, for example relating to the type of analysis that is to be performed.

The search request can be received in any one of a number of ways, but is typically provided by the client device to the one or more processing systems via a web or other network based arrangement, so that processing is performed independently of the client device.

At step 110, the one or more processing devices generate a query using the parameter values. The query can be of any appropriate form, depending for example on the nature of the target datasets. So for example, the query could be a REST (Representational State Transfer) query, SQL query, programmatic query, or the like, and could include one or more query terms, depending on the nature of the dataset(s), how the dataset(s) are structured and the data to be extracted. The query is typically generated using predetermined rules associated with the relevant dataset(s).

At step 120, the one or more processing devices apply the query to one or more datasets to obtain retrieved data, in accordance with standard querying techniques, and depending on the nature of the query and the respective dataset.

At step 130, the one or more processing devices process the retrieved data to generate results data compliant with one or more criteria, such as privacy criteria. The manner in which this is performed will vary depending on the preferred implementation, but typically involves creating consolidated merged data, and then analysing this to ensure the criteria are satisfied. In the event that this is not the case, additional action can be performed, such as filtering the data and/or creating a modified query, until the criteria are met.

Once the criteria are met, at step 140, a representation of the results data is generated. The representation can be of any form, depending on the nature of the data under consideration. In one particular example, the representation includes a geospatial representation, allowing the user to visualise the results of the query in association with specific geographic regions, which is particularly useful when analysing certain types of information. In this regard the term region will be understood to include a geographical area and/or a specific geographical location and use of the term region is not intended to be limiting.

At step 150, the representation can be returned to the client device via the communications network, allowing this to be displayed to the user.

The above described arrangement therefore allows a search request to be provided from a client device, with the datasets being queried and results generated on the fly and returned to the client device. This arrangement is beneficial as it ensures that the user of the client device is not provided with access to the raw data contained in the datasets, whilst further ensuring that any results provided are compliant with relevant criteria, allowing requirements, such as privacy, integrity or quality requirements, to be met. Nevertheless, the data in the datasets is accessed based on the parameter values specified by the user, meaning the results are supplied in a context of interest to the user. This means that the content of the results data can be tailored to make it as relevant as possible to the user, thereby ensuring that the most information can be obtained within the context of the user's specific request. This therefore balances the need to maintain privacy, whilst ensuring value provided by the information is maximised. Additionally, this approach allows the results data to be created based on live data, meaning it is as up to date as possible, avoiding the problem of outdated data that often occurs with traditional approaches to maintaining privacy or other requirements.

A number of further features will now be described.

To determine if the criteria are satisfied, the one or more processing devices typically compare the retrieved data to the one or more criteria and if the one or more criteria are not satisfied, either selectively processing the retrieved data in accordance with the results of the comparison or generating a revised query to obtained alternative retrieved data. Thus, the system compares the retrieved data to criteria, such as privacy criteria, to ensure these are satisfied and in the event that this is not the case, the retrieved data is modified, either by further processing of the data and/or by modifying the query to obtain alternative retrieved data from the dataset. This process can be repeated, for example as part of an iterative procedure, until the one or more criteria are met.

The manner in which the comparison is performed will vary depending on the preferred implementation and the nature of the criteria. Typically, this will involve performing a statistical analysis, for example to determine if the data has been anonymised to a sufficient degree, using the concept of k-anonymity, or that is meets integrity or quality requirements.

The processing of the retrieved data can be performed in any suitable manner. For example, this can include filtering the retrieved data, and in particular, progressively filtering the data until the one or more criteria are satisfied. For example, the filtering process could involve removing data that is not required, or of less importance. Additionally and/or alternatively the retrieved data can be aggregated, for example by combining the retrieved data into supersets, spatially aggregating the data, combining ranges within the data, or the like. These techniques can be used in combination and in particularly iteratively and/or interactively, as required.

The processing of the retrieved data can be performed using a combination of manual and automated processes and therefore could be performed in accordance with user input commands, using parameters, such as filtering or processing parameters, and spatially. Example techniques will be described in more detail below.

In order to process the data, the one or more processing devices typically create a data store and store the retrieved data in the data store, allowing this to be processed in the data store. As part of this process, the processing devices typically merge retrieved data from a number of datasets in the data store. Whilst the use of a separate data store is not essential, this is useful as it allows the retrieved data to be isolated during the merging and processing stages, so that this can be processed in isolation, whilst preventing the retrieved data being made available until it can be ensured that the one or more criteria are satisfied. Depending on the volume of retrieved data, the data store is preferably created in memory of the one or more processing devices, allowing the data to be more easily and rapidly manipulated, although this is not essential and any suitable arrangement could be used.

As mentioned above, the process is typically performed at least in part using parameters. The parameters can include global parameters independent of the datasets, which are used in processing and presentation of the results data, filter parameters related to the dataset(s), which are used in filtering data to generate results data, processing parameters used in processing the retrieved data and/or spatial parameters used in generating a spatial representation of the results data. The filter parameters typically include attribute parameters directly mapped to parameters of the at least one dataset, virtual parameters indirectly mapped to parameters of the at least one dataset or logical parameters that are used in controlling processing of the attribute parameters. Thus, it will be appreciated that specifying the various parameters allows the selection and processing of retrieved data and generation of the representation to be controlled, allowing desired results and visualisations to be obtained.

As part of the above process, the one or more processing devices typically provide a list of available datasets to the client device via the communications network and receive an indication of a user selection of one or more available datasets via the communications network. Following this, the one or more processing devices determine one or more selected datasets, identify parameters associated with the selected datasets and, provide an indication of available parameters to a client device via a communications network. Accordingly, this allows the one or more processing devices to display available datasets to a user, so that the user can select the datasets of interest. Once these have been displayed, the processing devices can identify parameters associated with the datasets, allowing the user to define parameter values of interest. This ensures parameters relevant to the dataset are defined, thereby allowing the context of data of interest to be defined in the user's search.

For example, in the event that the datasets include health related information, the user could request to view data from datasets relating to different demographics, different medical conditions or symptoms and/or different geographical regions. Once selected, the processing devices can examine the datasets and identify the parameters specified therein which can be used for searching. This could include information such as age, gender, or the like, allowing the user to define values and/or ranges of values, such as to select a specific gender and age range, allowing the data for those specified values to be retrieved.

The one or more processing devices can also perform a statistical analysis and provide results of the statistical analysis with the results data. This can be used to allow a user to determine the likely accuracy and relevance of the results data, for example to provide information regarding confidence intervals associated with the data, information regarding the levels of privacy compliance, the degree of filtering and aggregation performed, or the like, allowing the user to understand how the results can be interpreted.

The representation could be of any suitable form and could include numerical values or the like. More typically however, the representation includes a geospatial representation and/or a layer for display as part of a geospatial representation. In this regard, the geospatial representation could include a number of regions, such as individual areas and/or locations, and indicators at least partially indicative of results data associated with each region, which in one example includes a range of values for each region. This can be used to allow users to more easily visualise the results data, making the results data easier to interpret. This is particularly useful when trying to identify trends associated with geographic regions, for example when monitoring trends in health data or the like.

In one example, the one or more processing devices process the retrieved data by aggregating retrieved data for different regions. This allows data for different regions to be combined when being displayed as part of the representation, in order to ensure that privacy requirements associated with the data are met. Additionally and/or alternatively, the processing can also include aggregating other ranges of data.

In one preferred example, the one or more processing devices provide the representation to the client device, receive an indication of modified parameter values from the client device, use the modified parameter values to determine a modified representation and providing the modified representation to the client device. This allows the user to view results of a search and in the event that these are not suitable or do not provide the required information, the user can repeat the process by updating the parameter values associated with the original search. It will be appreciated that this is possible because the one or more processing devices operate to perform searching of raw datasets, using this to generate retrieved data which is then processed in order to generate results data that is compliant with necessary criteria. Thus, searching can be performed repeatedly until the user obtains results that are required.

Accordingly, the above described process allows retrieved data to be customised based on parameters values provided by the user and hence within the context of the searching being performed by the user, whilst ensuring that the results data meets privacy requirements. This is different to traditional techniques in which datasets are analysed in order to generate compliant datasets in a context independent fashion. Whilst the resulting compliant datasets are then provided allowing these to be analysed in context, this often means data is overly obfuscated, limiting the value of the data. Additionally, the above described process can be performed on live data, meaning the results data supplied to the user are as up to date as possible.

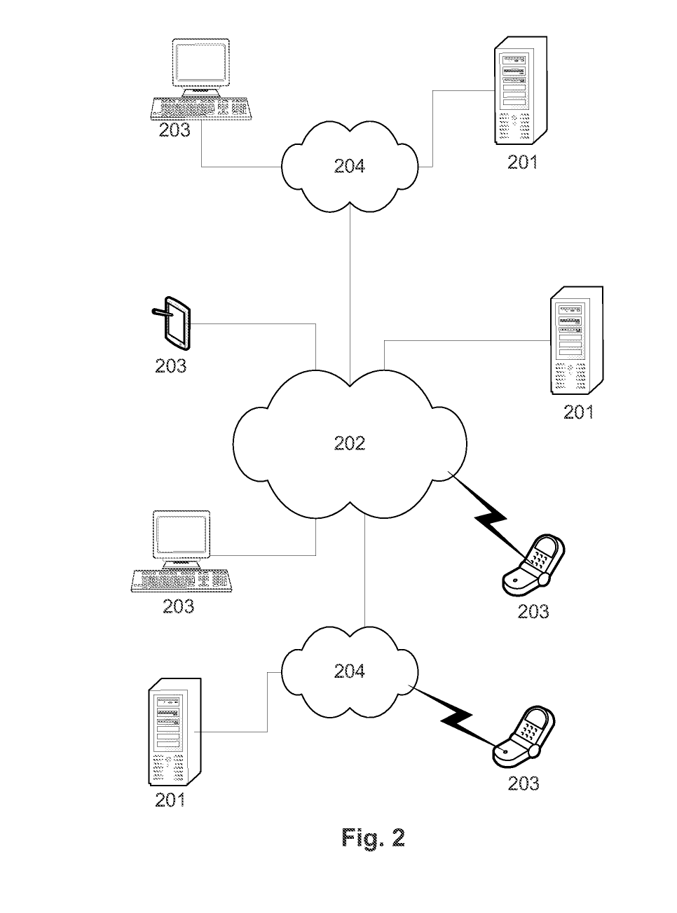

In one example, the process is performed by one or more processing systems operating as part of a distributed architecture, an example of which will now be described with reference to FIG. 2.

In this example, a number of base stations 201 are coupled via communications networks, such as the Internet 202, and/or a number of local area networks (LANs) 204, to a number of client devices 203. It will be appreciated that the configuration of the networks 202, 204 are for the purpose of example only, and in practice the base stations 201 and client devices 203 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In one example, each base station 201 includes one or more processing systems 210, each of which may be coupled to one or more databases 211. The base station 201 is adapted to be used in constructing queries, processing retrieved data and generating representations. The client devices 203 are typically adapted to communicate with the base station 201, allowing parameter values to be defined and allowing representations to be viewed.

Whilst the base station 201 is a shown as a single entity, it will be appreciated that the base station 201 can be distributed over a number of geographically separate locations, for example by using processing systems 210 and/or databases 211 that are provided as part of a cloud based environment. However, the above described arrangement is not essential and other suitable configurations could be used.

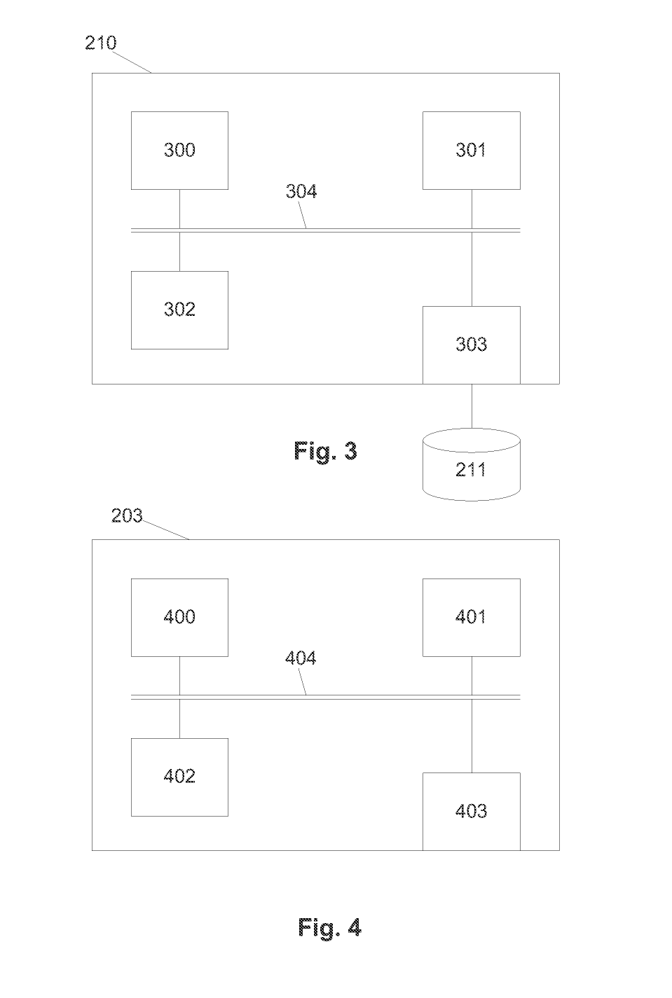

An example of a suitable processing system 210 is shown in FIG. 3. In this example, the processing system 210 includes at least one microprocessor 300, a memory 301, an optional input/output device 302, such as a keyboard and/or display, and an external interface 303, interconnected via a bus 304 as shown. In this example the external interface 303 can be utilised for connecting the processing system 210 to peripheral devices, such as the communications networks 202, 204, databases 211, other storage devices, or the like. Although a single external interface 303 is shown, this is for the purpose of example only, and in practice multiple interfaces using various methods (e.g. Ethernet, serial, USB, wireless or the like) may be provided.

In use, the microprocessor 300 executes instructions in the form of applications software stored in the memory 301 to allow the required processes to be performed. The applications software may include one or more software modules, and may be executed in a suitable execution environment, such as an operating system environment, or the like.

Accordingly, it will be appreciated that the processing system 210 may be formed from any suitable processing system, such as a suitably programmed client device, PC, web server, network server, or the like. In one particular example, the processing system 210 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

As shown in FIG. 4, in one example, the client device 203 includes at least one microprocessor 400, a memory 401, an input/output device 402, such as a keyboard and/or display, and an external interface 403, interconnected via a bus 404 as shown. In this example the external interface 403 can be utilised for connecting the client device 203 to peripheral devices, such as the communications networks 202, 204, databases, other storage devices, or the like. Although a single external interface 403 is shown, this is for the purpose of example only, and in practice multiple interfaces using various methods (e.g. Ethernet, serial, USB, wireless or the like) may be provided.

In use, the microprocessor 400 executes instructions in the form of applications software stored in the memory 401 to allow communication with the base station 201, for example to allow for selection of parameter values and viewing of representations, or the like.

Accordingly, it will be appreciated that the client devices 203 may be formed from any suitable processing system, such as a suitably programmed PC, Internet terminal, lap-top, hand-held PC, smart phone, tablet, PDA, web server, or the like. Thus, in one example, the processing system 210 is a standard processing system such as an Intel Architecture based processing system, which executes software applications stored on non-volatile (e.g., hard disk) storage, although this is not essential. However, it will also be understood that the client devices 203 can be any electronic processing device such as a microprocessor, microchip processor, logic gate configuration, firmware optionally associated with implementing logic such as an FPGA (Field Programmable Gate Array), or any other electronic device, system or arrangement.

Examples of the processes for generating a representation of data in a dataset will now be described in further detail. For the purpose of these examples it is assumed that one or more processing systems 210 act to host webpages allowing the user to browse lists of datasets, define parameter values and view representations using one of the client devices 203. The processing system 210 is therefore typically a server which communicates with the client device 203 via a communications network, or the like, depending on the particular network infrastructure available.

To achieve this the processing system 210 of the base station 201 typically executes applications software for hosting webpages and performing other including searching and processing of retrieved data, with actions performed by the processing system 210 being performed by the processor 300 in accordance with instructions stored as applications software in the memory 301 and/or input commands received from a user via the I/O device 302, or commands received from the client device 203.

It will also be assumed that the user interacts with the processing system 210 via a GUI (Graphical User Interface), or the like presented on the client device 203, and in one particular example via a browser application that displays webpages hosted by the base station 201. Actions performed by the client device 203 are performed by the processor 400 in accordance with instructions stored as applications software in the memory 401 and/or input commands received from a user via the I/O device 402.

However, it will be appreciated that the above described configuration assumed for the purpose of the following examples is not essential, and numerous other configurations may be used. It will also be appreciated that the partitioning of functionality between the client devices 203, and the base station 201 may vary, depending on the particular implementation.

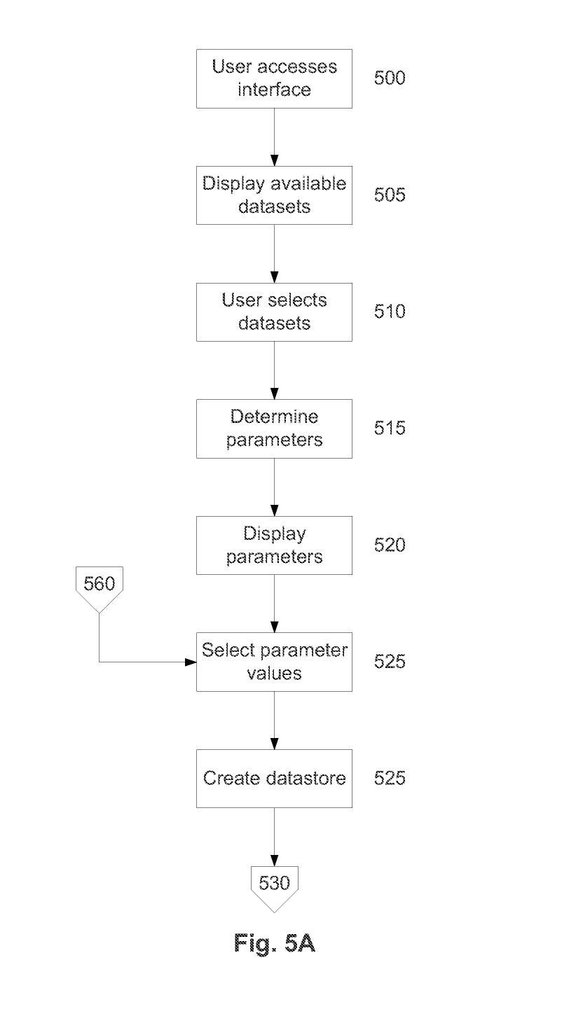

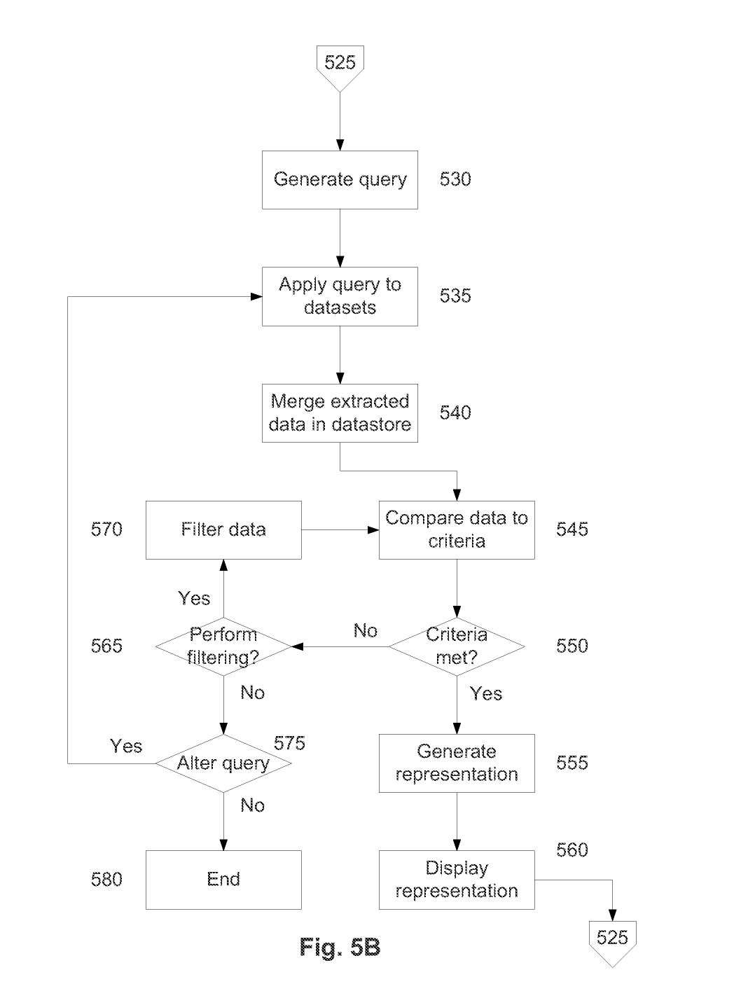

An example process for generating a representation of data in a dataset will now be described in further detail with reference to FIGS. 5A and 5B.

In this example, at step 500 the user uses the client device to access a user interface forming part of a webpage hosted by the processing system 210. At step 505, the processing system 210 determines available datasets, for example by accessing a list of datasets stored in in database 211, and causes an indication of these to be displayed on the user interface.

At step 510, the user selects one or more relevant datasets, for example, by indicating a selection of these from the list. An indication of the selection is used by the processing system 210 to determine relevant parameters that can be used in the searching, which can then be displayed to the user at step 515, allowing the user to select relevant values at step 520.

In general, the parameters can include system variables or global parameters, which are independent of the dataset and which are used to control the processing and presentation of results. Additionally parameters can include input parameters that are typically dataset specific and are therefore displayed based on an understanding of the content of the dataset. There may also be spatial parameters, which exist in between dataset specific and global parameters. In each case, it will be appreciated that the parameter values can be defined using techniques appropriate for the respective parameters, such as entering values, selecting values from drop-down lists or the like.

At step 525, the processing system 210 creates a data store for analysing retrieved data. The data store is typically created in memory and may be a temporary store used for processing a specific set of retrieved data.

At step 530, the processing system 210 generates one or more queries using the respective input parameters. The nature of the queries will vary depending on the nature of the dataset and could include an SQL query if the dataset is accessible via a database management system (DBMS), or a programmatically defined query, for example in the event that the dataset is stored in the form of a data file, such as an Excel file, CSV (Comma Separated Variable) file, or the like, as will be appreciated by persons skilled in the art.

At step 535, the queries are applied to one or more datasets, allowing data to be retrieved therefrom. The retrieved data is typically written into the data store where data extracted from the different datasets can be merged into a consolidated set of retrieved data at step 540. Thus, for example, health data retrieved from a health dataset could be merged with demographic information retrieved from census data, allowing correlations between populations and health within a given geographic region to be examined

At step 545 the retrieved data is compared to criteria. The criteria are typically defined for the respective datasets, and typically impose limitations on the degree or extent to which individual data records can be disclosed. In general the criteria are privacy criteria and could be example be expressed in terms of spatial probability or k-anonymity requirements.

At step 550 it is determined if the criteria are met, and if so, a representation can be generated by the processing system 210 at step 555, with this being provided to the client device for display at step 560.

More typically however, the criteria will not initially be satisfied and accordingly the process proceeds to step 565 to determine if filtering, such as privacy filtering, of the retrieved data is to be performed. Filtering is typically initially used in an attempt to meet the criteria, by obfuscating and/or aggregating the retrieved data. Filtering is typically performed in accordance with filtering parameters defining the types of filtering that can be performed. For example this might specify a certain degree of geographical granularity required, allowing the processing system 210 to aggregate data from different regions up to the defined level. Assuming filtering is to be performed, this occurs at step 570, with the filtered data then being compared to criteria at step 545, allowing the processing system to assess whether the criteria are satisfied at step 550.

However, as there is generally only a limited extent to which filtering may assist, if a defined amount of filtering is performed, for example if all filtering allowed by the filtering parameters has been performed, then alternatively at step 575 an assessment is made as to whether an alternative query can be prepared. The revised query could be used in an attempt to obtain alternative or modified retrieved data, and this could be prepared either automatically and/or in accordance with user input. For example, the user could be presented with an indication of why the previous query did not meet requirements, allowing them to modify the parameter values, so that alternative data can be retrieved. Once prepared, the new query can be executed and the new retrieved data processed according to steps 535 onwards.

Alternatively, the user could indicate that a revised query is not to be used, in which case the process can end at step 580, without results data being provided to the user, thereby ensuring requirements, such as privacy requirements are met.

Once a representation has been displayed to the user, the user can then choose to review the parameter values associated with the results data, for example by modifying either the global or input parameters, allowing alternative results to be generated and displayed. This allows the user to iteratively explore results data, thereby maximising the chance of them being able to create results meeting their needs.

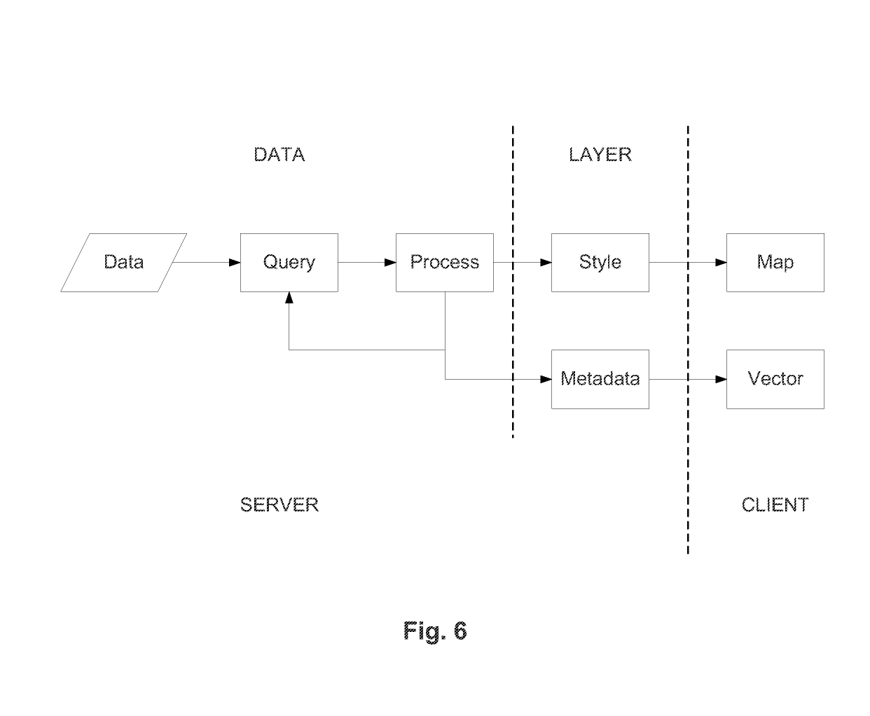

An example overall workflow will now be described further with respect to FIG. 6.

In this example, a server corresponding to the processing system 210 operates to generate a query to access the data. The query results are processed and filtered, with this process being repeated until criteria are met. Once this is completed, results data are generated, which can then be processed to apply a style to generate the representation, which in this example is provided to the client device in the form of a thematic map representation. Additionally, the results data are processed to generate metadata, which can for example be incorporated into a vector layer for the GIS platform.

Thus, this highlights that the user only ever sees processed results, meaning that requirements such as adherence to risk based privacy policies, or the like, can be absolutely guaranteed to the data custodian, thereby minimising privacy risks and giving the custodian confidence that access to the data should be provided.

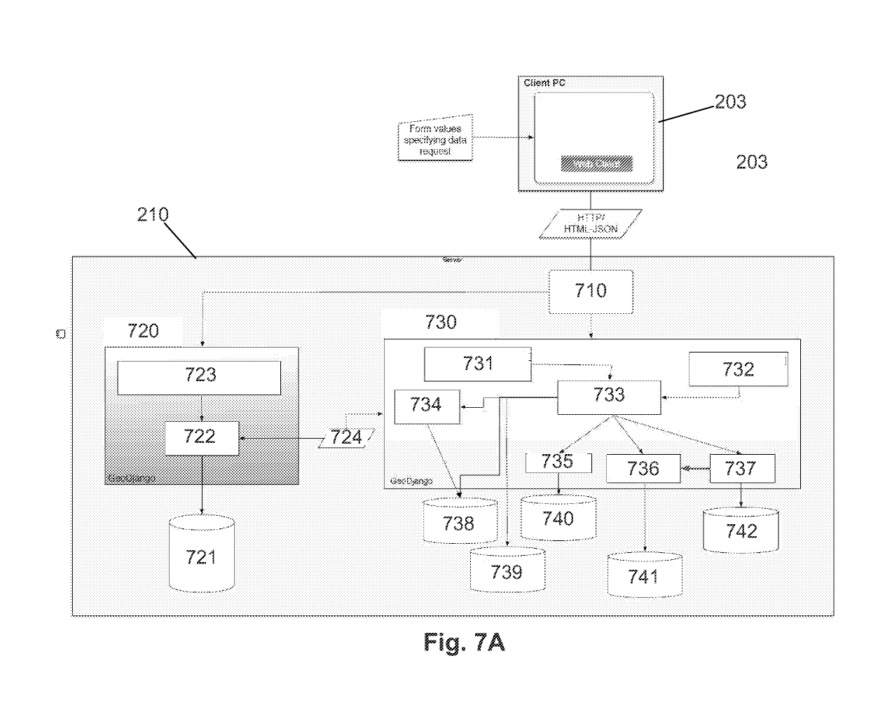

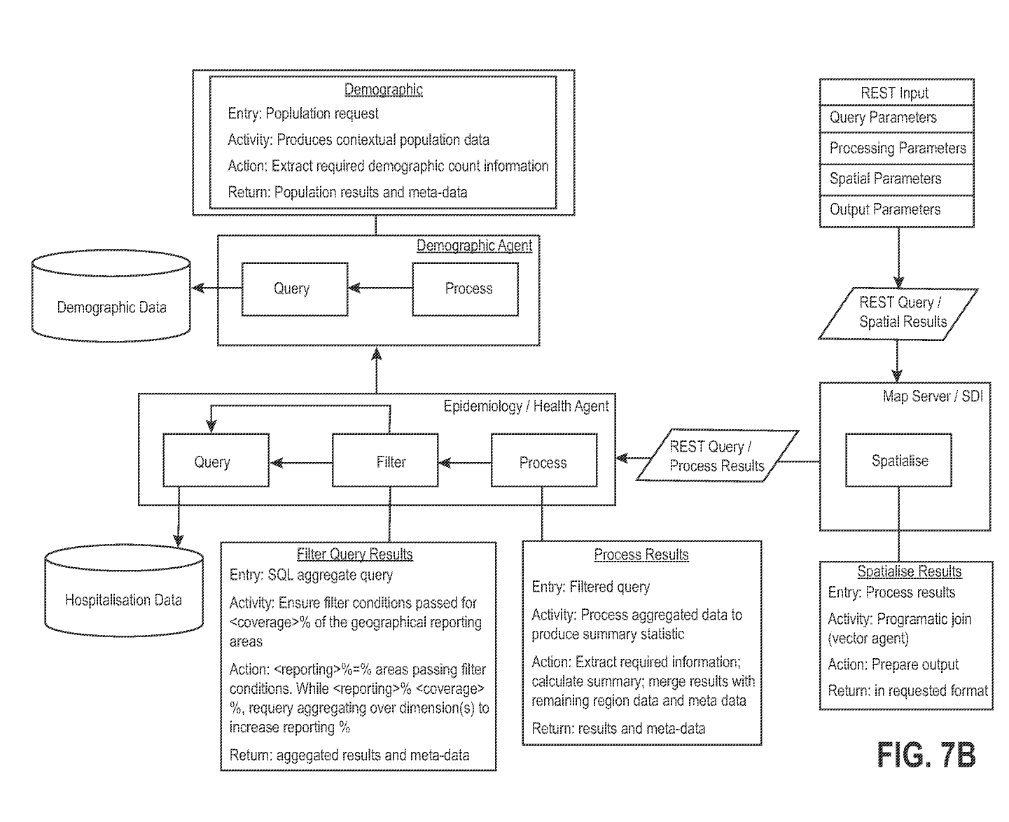

A specific example system for performing this workflow is shown in more detail in FIG. 7A.

In this example, the client device 203 and server in the form of a processing system 210 are shown. The client device 203 implements a web client, allowing the client device 203 to be used to provide parameter values by completing form values, and then subsequently display HTTP webpages including the representation.

The server 210 can implement a web server 710 connected to a persistence engine 720 and data processing engine 730. The persistence engine 720 stores persistent data in a persistent data store 721, accessed via a persistence module 722 and an advanced visualisation module 723. The persistence engine 720 can communicate with the data processing engine 730 via Javascript Object Notation (JSON). The data processing engine 730 includes a user interface generation module 731 and visualisation module 732 coupled to a map server 733. The map server 733 is coupled to a number of agents, which in the current example includes an style agent 734, ABS agent 735, demographic agent 736 and health agent 737. These provide access to respective data stores including a catalogue (DBMS) data store 738 and a vector data (spatial DBMS) data store 739, for generating a GIS representation and an ABS census data store 740, a demographic or population data store 741 and a health data store 742, for providing access to census data, demographic or population information and health related information respectively.

Thus, it will be appreciated that the system uses a number of agents, each of which interacts with a respective dataset allowing the data to be retrieved therefrom. An example of the workflow for the system of FIG. 7A is shown in more detail in FIG. 7B.

Thus, in this example, it can be seen that the demographic agent processes a demographic dataset to retrieve demographic data, which is sent to a health agent, which processes health (hospitalisation) data, aggregates this with the demographic data and then performs filtering to ensure privacy requirements are met. Once completed, results data is provided to the map server, which spatializes the results to generate a GIS map layer.

A specific example relating to health data will now be described in more detail.

In this example, a processing module parses the input REST query prepared by a client interface, with the REST query specifying the input parameters to a data agent API, allowing the query to be applied to the datasets and the retrieved data processed. In one example, there are four types of parameters, including global parameters, data parameters, processing parameters, and spatial parameters.

Global parameters are parameters that are selected by the user independently of the dataset, but the values of which influence the calculation and presentation of the processing results. The global parameters can be set as defaults and disabled. However, if exposed to the user, can enable the user to fine tune aspects of the query, such as the rate multiplier used, or the sensitivity of the analysis with respect to the number of suppressed results returned by enabling the user to control a coverage variable. This method also enables a user to set the parameters of their choosing, the parameters then persist in the client and are applied to all subsequent queries.

The filter parameters are used to generate the data query (e.g. SQL) required to extract the relevant data from the data store and are dataset specific. That is, the filter parameters encapsulate the logic required to generate a user defined subset, or snapshot, of the data store(s) associated with the agent. As the agent approach is flexible, the filter is constructed in accordance to the data store type. For example, if the data is store in a DBMS (either file or server) that is SQL compatible, the filter query comprises an SQL string. However for storage mechanisms that do not support in place queries, the query will need to be executed programmatically, for example, Excel or CSV files.

As the query is programmatically constructed, there are a number of filter parameter types, each with different associated logic. This enables both greater usability, and increased flexibility with respect to a user's interaction with the data. The filter parameters are grouped into three distinct types, each with a different associated logic in converting the user input into a data query. This approach enables a high degree of flexibility with respect to a user's ability to specify a data subset, or view, of interest, and embodies the user pull mechanism within the system. The three filter parameters types are attribute, virtual, and logical.

Attribute parameters are those that can be mapped directly to a data attribute from a user query, and are divided into a number of subsets, or categories. Each category type is presented to the user, and parsed in a different way. At a broad level the categories are defined as either ranged (e.g. age, date), or not (e.g. gender, race), with subcategories defining the data type of the attribute (e.g. INT, FLOAT, LIST). These categories are used to automatically drive the logic associated with both presenting the attributes to the user, and in parsing the user input. For example, for a range query, an upper and lower input entry is presented to the user, and is subsequently parsed as the upper and lower bounds to be imposed on the associated attribute filter. Attribute filter parameters represent the base level for developing the filter query as there is a direct correspondence between the attribute parameters and an attribute in the data (e.g. database table column)

The metadata required to process the logic between the generation of the user interface and the resulting query can be stored in a DBMS for greater flexibility, the combo box interface for list attribute can be derived from outrigger tables where available. However, for certain variables, virtual data values are required for increased usability; in such cases, bespoke metadata is required indicating the value and virtual nature of the data value. For example, due to the manner in which the ABS stores data, i.e. counts for males, females, and persons, when querying gender, it is useful to encapsulate this storage mechanism due to user familiarity. Thus, the user views persons as a query value for gender, but this value is omitted when generating the SQL query as no gender filter in the SQL will result in both male and female (i.e. persons) being returned.

The logic required to process the user input can vary in complexity, for example, if a simple age range of 0-25 is given, the resulting generated query includes ages greater than or equal to 0, and less than or equal to 25. However, more complex parsing is required for a list input, for example, 0-15, 25+ filters ages 0 to 15 inclusively, and 25 onwards. This form of input increases flexibility, for example, enabling a user to enter bespoke age ranges for normalised rate calculations, or non-contiguous age queries.

Virtual parameters are used to provide a layer of abstraction between the user, and how the data is stored. For example, storing the time attribute in the database as DATE offers the greatest flexibility when accessing the data, but does not necessarily reflect how a user would prefer to interact with the data. In the case of time, researchers may want access to fine grained time slices of the data, but policy makers are more generally interested in reports at the year level, either calendar year or financial year. Using the concept of a virtual attribute, such users can be presented with a “financial year” attribute, which is then mapped to a date filter within the generated query, for example 01/07/YY to 30/06/YY+n.

In a similar manner, a user could also be given a temporal query view comprising seasons, enabling rapid access to comparisons of disease rates between winter and summer By embedding the logic required to map from various, more semantically meaningful, temporal descriptions to a date query, the usability of the interaction increases. This enables the user to interact with the virtual attributes, removing the complexity of generating the corresponding query over the method used to store the data. Importantly, this approach facilitates the storing of data as data, using a layer of logic to abstract the data complexity where necessary.

Logical parameters are those used to drive the logic when processing attribute parameters, and as such, do not represent fields of the data. For example, age and year can have a number of mutually exclusive query inputs, such as financial year and calendar year for a date query; this is shown in detail in Table 1. Logical parameters define the linking between different input mechanisms, and enable a user to select the input mechanism of their choice where only one input mechanism is valid per query. Consequently, logical attributes define both the user input, and attribute parsing of the linked attribute(s).

TABLE 1

| Logical | Value | Attribute | Description | Entry |
|---|---|---|---|---|
| Age | Age | Age | User selected | Range from |
| Type | | | age range | lower to upper |
| | Age Group | Age | Age group | Combo box, |
| | | | range, where | choose from |
| | | | age groups are | available ranges, |
| | | | pre-defined | upper to lower |
| | Age Range | Age | User selected | Integer list input |
| | | | age range | (e.g. 0-15, 15-35, |
| | | | | 36-50, 51-60, |
| | | | | 61+) |
| Year | Financial | Financial | Select data | Combo Box |
| Type | | Year | range accruing | |
| | | | to financial year. | |
| | Calendar | Virtual | Select a year | Combo Box |
| | Year | Date | range from those | |
| | | | available. | |

The processing parameters are those required to calculate the processed output of the agent. The processing of health data can range in complexity from returning counts, to crude rates or standardised rates and rate ratios. The type of process dictates the aggregation method to be used when querying the data. For example, a simple calculation would aggregate by summing hospitalisation events within an area, while a complex, age standardised query requires the data to be in the form of an aggregation of events by age. The processing parameters are used to insert the logic within the parsed output query from the parameter parsing module.

The spatial parameters specify the desired output resolution. While the data can be stored as either point level data, or unit records aggregated to a spatial geometry layer (e.g. ABS statistical area). By considering geometry layers as nodes on a directed acyclic graph, it is possible to programmatically aggregate the data to the requested spatial resolution. In this manner, it is possible to return data over attributes not stored in the data model for the agent. The spatial parameters are included in the execution logic of the query generated using the other input parameter types.

Once the input parameters have been defined, the data queries are generated and applied to the datasets, allowing retrieved data to be extracted. To achieve this, a data preparation module executes and parses the data view defined by a parse input module in order to ensure compatibility with the processing module. This requires a number of steps, including:
1. Executing the data query input in accordance with the specified spatial parameters;
2. Creating an in memory data store, for each geometry feature add both spatial features required (e.g. spatial context such as a unique ID), and corresponding feature level data subset; and,
3. Conflating the population context in the required format. The population data corresponding to the query is required for both the calculation of rates, and the determination of the spatial probability or k-anonymity.

A filter module parses the in memory data store to ensure adherence to various filter properties specified by the data providers, or custodians. A number of filters can be specified. For example, in the case of a health data agent, two filters are specified, one determining privacy and one determining the statistical reliability associated with the data view. The privacy filter masks those regions that do not comply with the specified privacy policy, in this case, the probability associated with re-identification in the presence of linked information. The statistical filter masks areas that do not comply with the reliability criteria outlined by a data provider, or specified in the global parameter set. As part of this filter, the age range aggregation is required to reach the desired coverage specified by a user.

The data filter module results are then passed to a data preparation module in order to apply any changes required. This could be a simple aggregation of the age ranges (e.g. group into n year age aggregates specified by the statistical reliability filter). However, more complex data manipulation mechanisms can be achieved by manipulating the initial query, for example, changing the spatial resolution. While such a method would produce the required result without the intervention of the user, an alternate approach is to enable the user to manipulate the query until the required outcome is achieved by giving feedback regarding the changes in various properties of the varying outputs.

The final two modules comprise the processing module, and a metadata module. The processing module calculates the required output summary statistic given by the processing parameter, with the output including both the required statistic along with any uncertainty, or confidence intervals, as required. The metadata module then determines the metadata associated with the generated results layer. This information includes data required to interpret the results stored within the layer, along with any provenance information required by the data provider. This information is displayed alongside any generated thematic maps in the form of text and tables within the legend. When data is exported to excel format, this information is stored within a metadata worksheet within the spreadsheet file.

An example of a user interaction with Health Agents, including examples of how a user can manipulate a query in order to obtain the desired outcome will now be described.

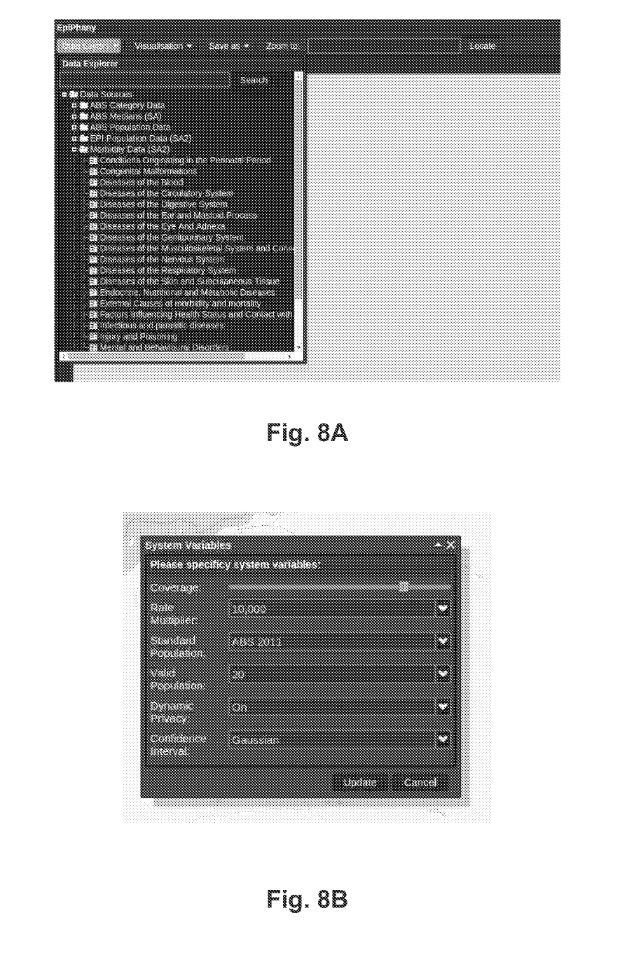

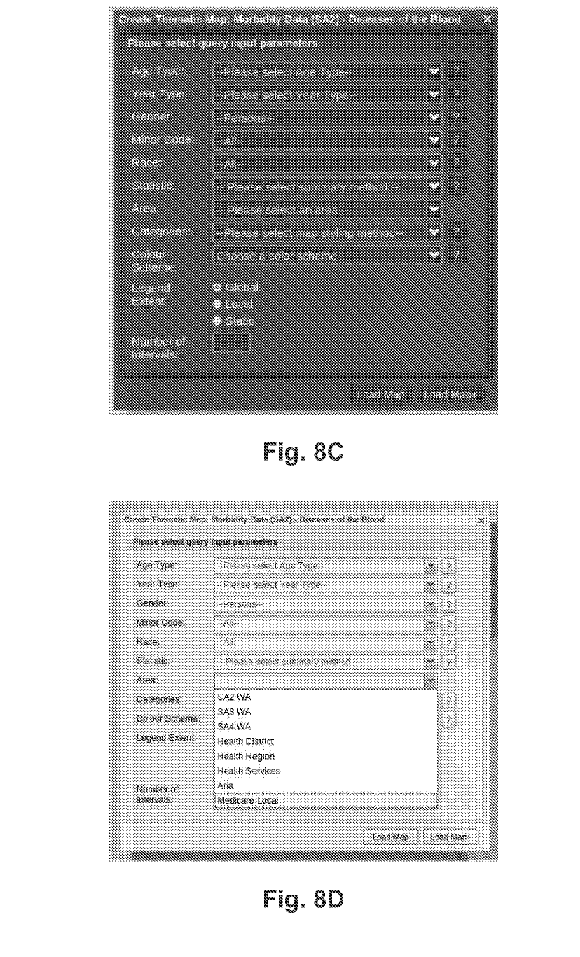

In this example, FIG. 8A shows a user view of the datasets made available through a Health Agent, with the datasets view representing a view on each data table as each dataset is an index into the table in the database. This adheres to the differentiation between how a user interacts with the data, and how the data is stored.

In this example, when a user requests access to a dataset, an input form can be generated on demand, based on the respective dataset, so that the form only contains those parameters that are relevant to the selected dataset, along with the spatial styling parameters that are available. FIGS. 8C and 8D are examples of how input parameter values can be displayed and specified, with global parameter values being defined as shown in FIG. 8B.

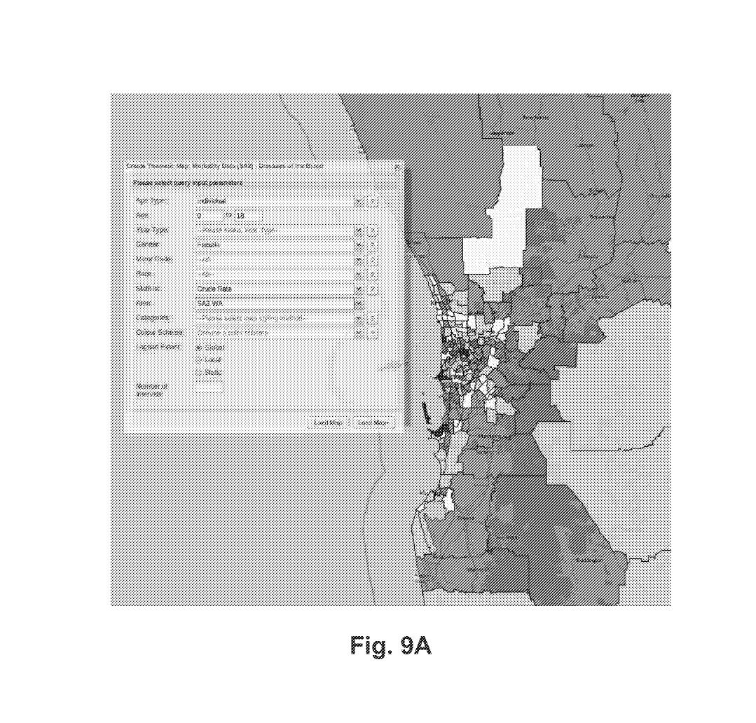

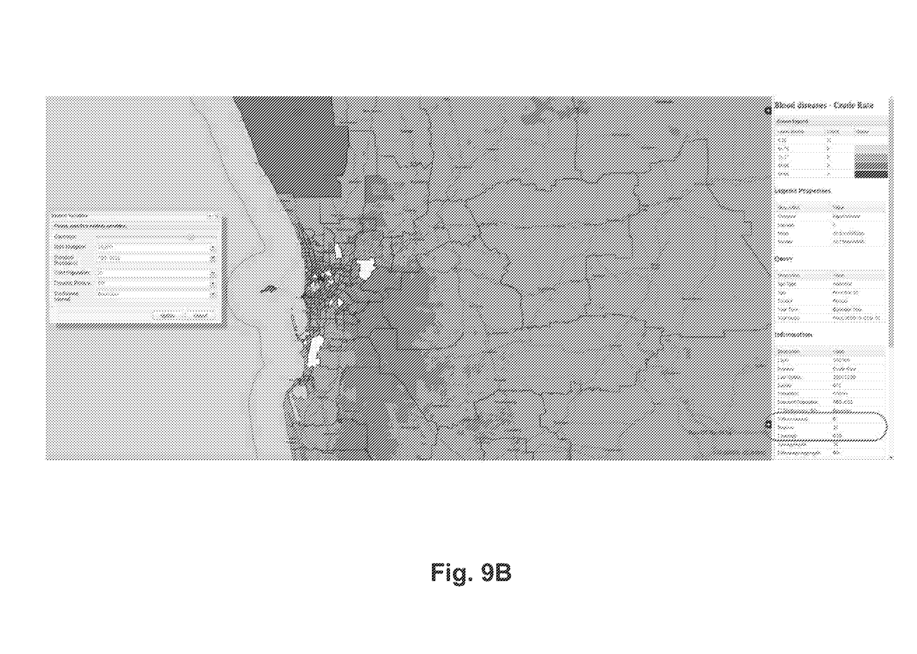

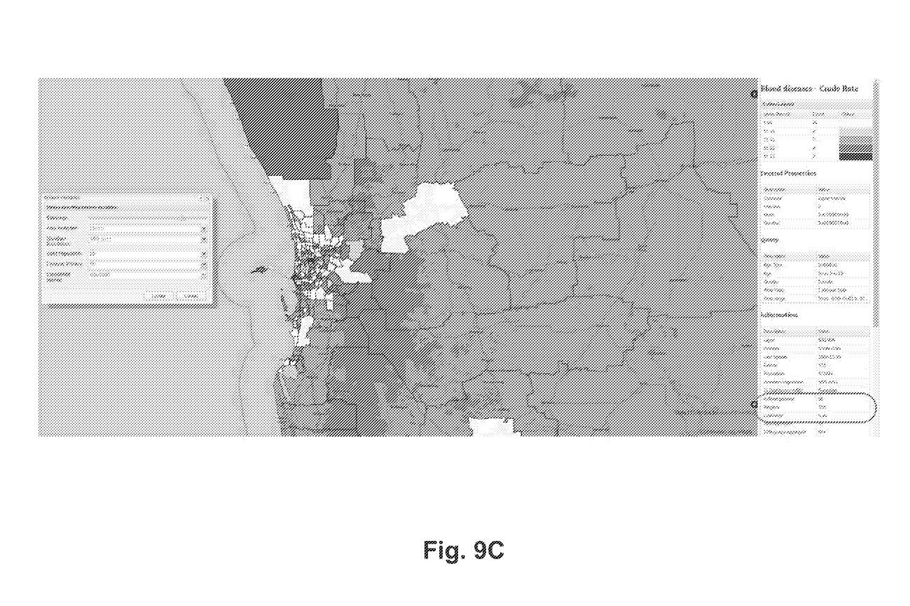

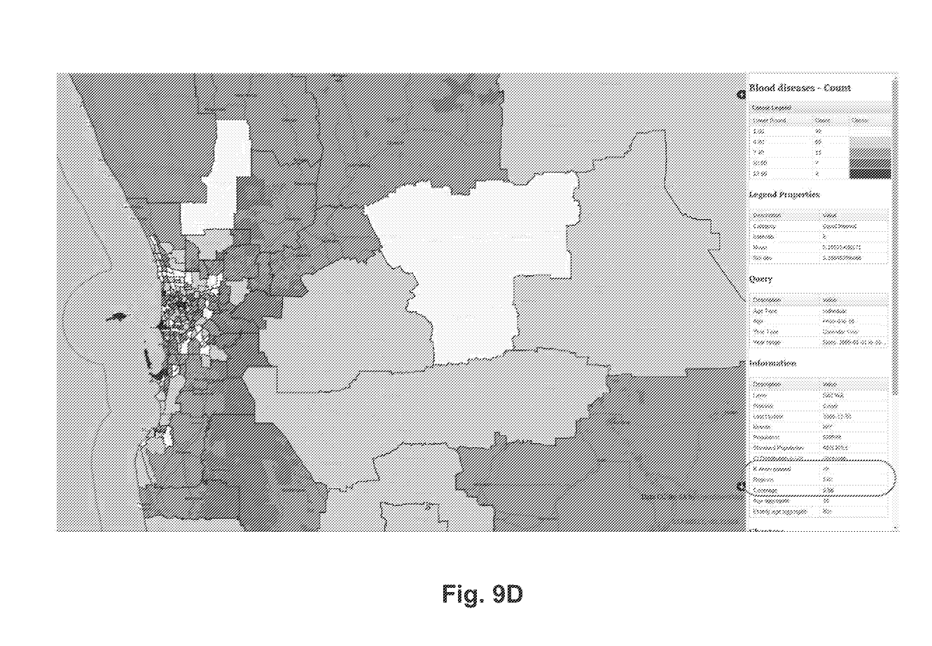

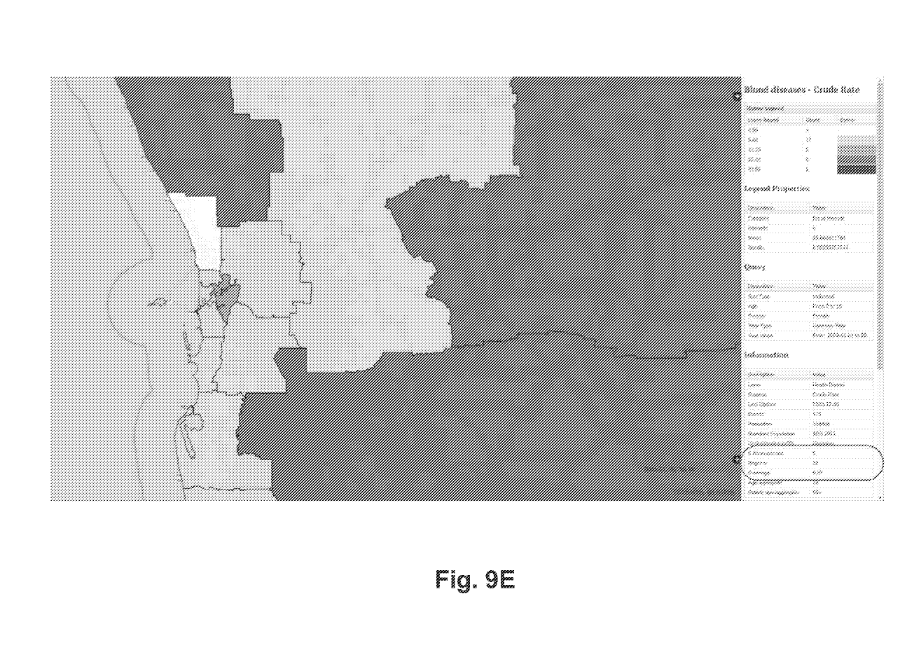

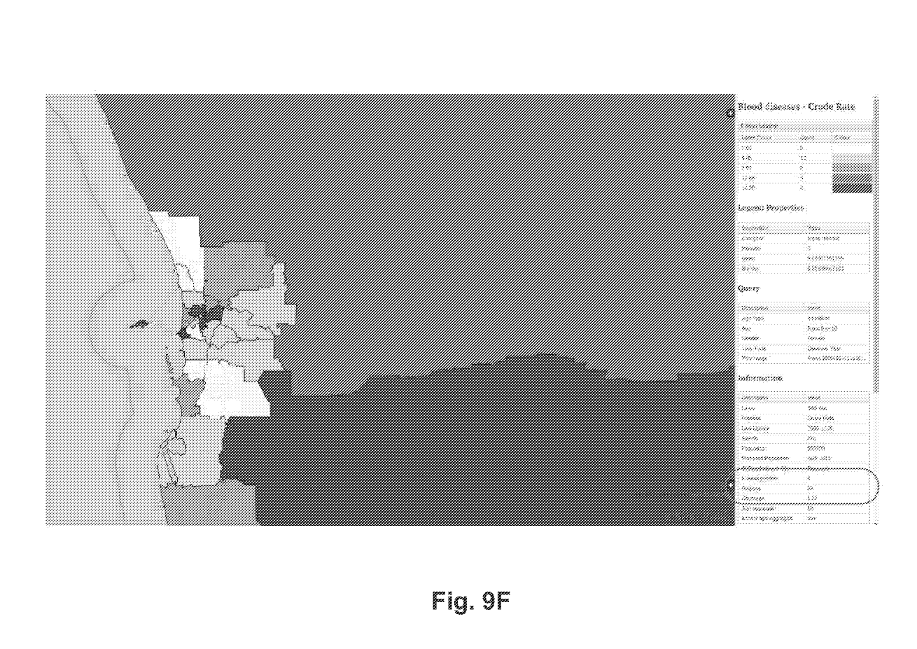

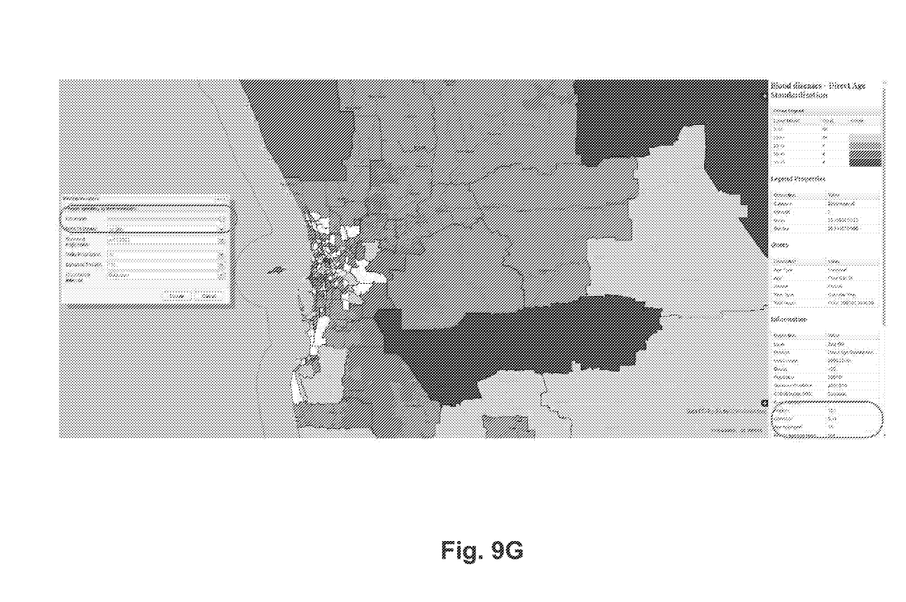

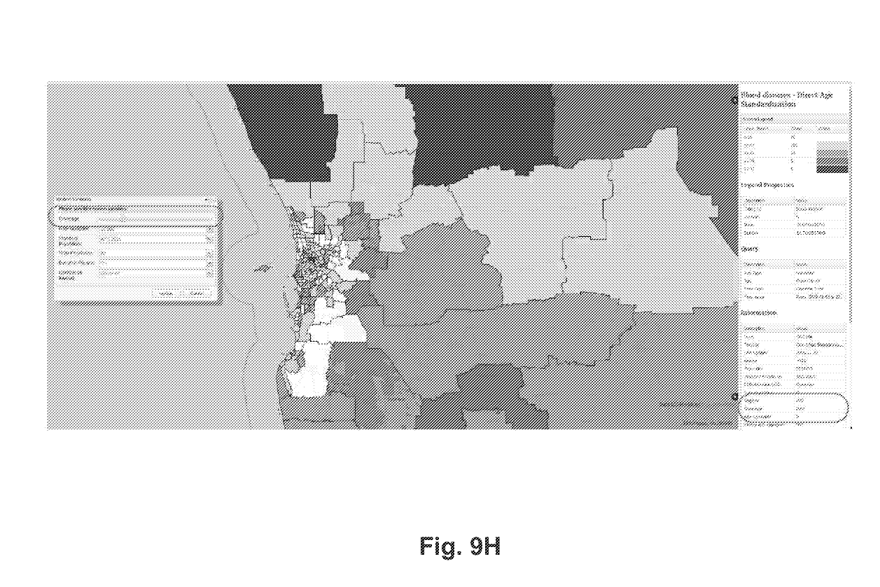

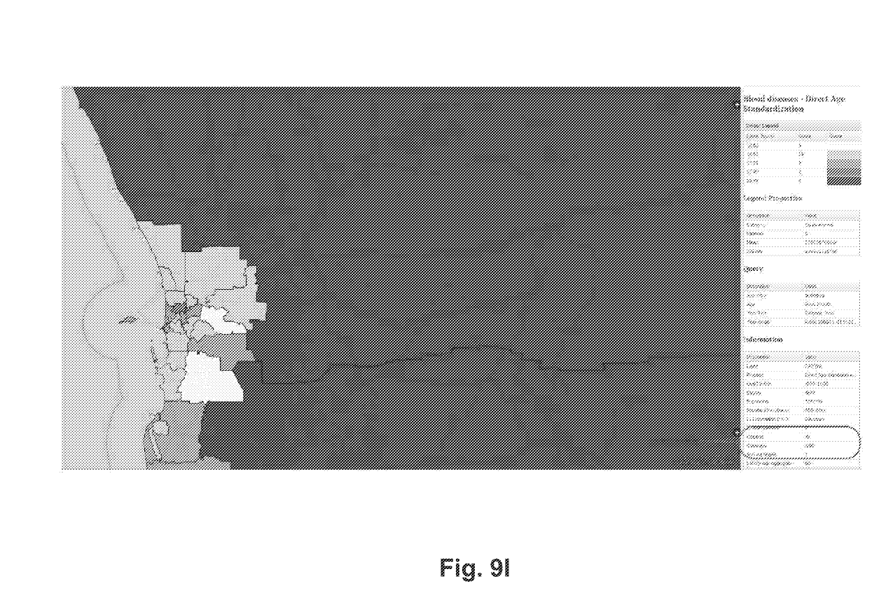

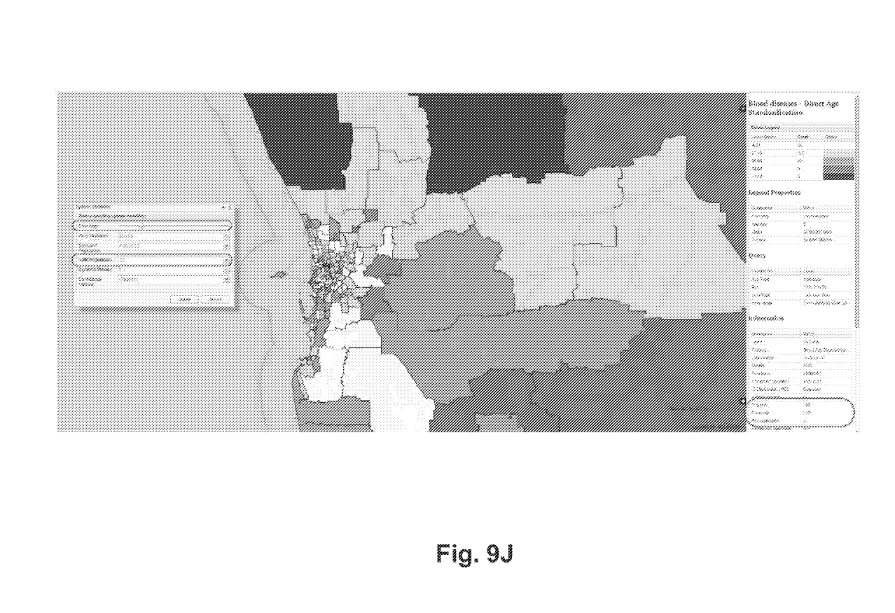

FIG. 9A shows an example query for calculating the crude rate, for females aged under 18, of specific blood diseases in at a spatial resolution corresponding to the ABS statistical area 3, which results in generation of a spatial representation including a corresponding thematic layer.

FIGS. 9B to 9F show how the query can be manipulated in order change the resulting thematic layer to meet the desired outcome. In this case, the aim is to return as many regions as possible while adhering to the age range (primary focus), and gender (secondary).

Coverage is the proportion of regions returned compared to the number of regions within the geometry layer. Both the thematic maps, and the metadata (also displayed in Table 2) demonstrate the effect of using different queries, dependent on privacy policy, and the desired resolution in either the “gender” dimension, or the spatial dimension. The sample data used in the query corresponds to a subset of simulated data that was designed to approximate a single year of hospitalisation events in Western Australia. As such, an alternate method that could be used to adjust the query was not available, that of adjusting the temporal resolution of the query.

TABLE 2

| FIG. | Query | Coverage | Privacy Passed | Regions |
|---|---|---|---|---|
| 9B | Female, aged 0-18, | 0.1 | 0 | 25 |
| | layer SA2, | | | |
| | Privacy off | | | |
| 9C | Female, aged 0-18, | 0.46 | 90 | 115 |
| | layer SA2, | | | |
| | Privacy on | | | |
| 9D | Persons, aged 0-18, | 0.56 | 49 | 140 |
| | layer SA2, | | | |
| | Privacy on | | | |
| 9E | Female, aged 0-18, | 0.97 | 6 | 32 |
| | layer Health | | | |
| | District, Privacy | | | |
| | on | | | |
| 9F | Female, aged 0-18, | 1.00 | 4 | 33 |
| | layer SA3, | | | |
| | Privacy on | | | |

These results highlight that aggregating regions and adjusting privacy filtering and ranges for the different regions, allows additional coverage to be obtained at the expense of granularity. Accordingly, this allows a user to adjust parameters and obtain a balance between required coverage and detail, whilst ensuring privacy is met.

FIGS. 9G to 9J show the influence of a number of methods that can be used to adjust the calculation of the age standardised rate (ASR) for the same subset of the data previously analysed. The age standardised rate is a method that can be used to normalise the disease rates across different areas by smoothing using a standard population. This method attempts to remove the influence of the population distribution within an area, making different areas directly comparable.

To determine the ASR online, a statistical reliability filter is introduced that aggregates age ranges until the filter condition is met. A smaller age aggregation amount is preferred with an aggregation equal to the age range present in the query resulting in the crude rate being calculated, i.e. the result is not comparable across areas. The age range aggregation influences the accuracy of the result, with the optimal being no age aggregation within the age ranges. The results presented do not need to incorporate a privacy filter as the methodology adheres to, or adapts, the privacy policies of the Department of Health, Western Australia. In presenting the ASR within a thematic map, no privacy filter is applied as the counts are not revealed as the statistically reliability, and the ASR algorithm prevents small counts. If the data is downloaded with counts included, count based privacy will apply.

Global parameters can also be used to change the outcome of the query. For example, a coverage parameter can be related to the proportion of regions returned by a query, with 1 indicating that an answer for all regions is preferred, with lower values generally returning fewer results, but with a higher accuracy. In general, if regional areas are of interest in the analysis, a higher coverage should be chosen, with a lower value being more suitable for the metro area. The valid population is a parameter used in the calculation of the statistical reliability filter, with higher numbers being more conservative, i.e. rejecting more areas due to lower statistical reliability, and lower values introducing greater uncertainty. The statistical reliability filter minimises the age aggregation level given the desired coverage. The FIGS. 9G to 9J, and corresponding table (Table 3), demonstrate the influence of the coverage, spatial resolution, and valid population on the query results. It should be noted, that an age aggregation equivalent to the age range results in the crude rate being calculated.

TABLE 3

| | | | | Age |
|---|---|---|---|---|
| FIG. | Query | Coverage | Regions | Aggregation |
| 9G | Female, aged 0-18, | 0.27 | 67 | 19 |
| | layer SA2, | | | |
| | Coverage 1.0 | | | |
| | (Privacy | | | |
| | applies) | | | |
| 9H | Persons, all | 0.8 | 200 | 2 |
| | ages, layer SA2, | | | |
| | Coverage 0.2 | | | |
| 9I | Persons, all | 1.0 | 33 | 2 |
| | ages, layer SA3, | | | |
| | Coverage 1.0 | | | |
| 9J | Persons, all | 0.85 | 213 | 2 |
| | ages, layer SA2, | | | |
| | Coverage 0.2, | | | |
| | valid population | | | |
| | of 10. | | | |

An example of the filtering process for privacy will now be described in more detail with reference to health care data.

In this regard, there are a number of outputs that are commonly used in health, such as aggregated counts, and summary statistics, including standardised rates that can be used to compare relative risks associated with a disease over different regions. A subset of these output was used to test the efficacy of the above described approach, including event counts, and a number of rate calculation methods, including crude rate, age standardised rate, and rate ratio.

The definitions of the parameters used are shown in Table 4 below.

TABLE 4

| Parameters | Denotes |
|---|---|
| e | An individual hospitalisation event. |
| O | Observed events. |
| N | Underlying population |
| i | Statistical spatial region i, where i = 1 . . . R |
| a | Age category a, where a = 1 . . . A |
| s | Standard population |
| S | Scaling factor used when reporting on rates |
| A₁ | Lower age range bound |
| A₂ | Upper age range bound |

e represents a single hospitalisation, and O an aggregation of observed events for a given ICD10 disease code or code group. A gender filter and a temporal filter can also be specified as a constraint when determining O. Thus, O is the sum of all events that matches the disease, gender and temporal filter. Similarly, O, is the sum of events within spatial region i that matches the given data filter condition, Oₐ is the sum of matching events with patients being of age a, and Oᵢₐ specifies the sum of matching events with patients of age a within spatial region i. Equation (1) details the determination of the disease incidence counts for each spatial region i, denoted by cᵢ(O).

$${c}_{i} ( O ) = {\sum }_{a = {A}_{1}}^{{A}_{2}} {O}_{ia} \qquad ( 1 )$$

In epidemiology, rates are used as an estimate of the underlying risk associated with a disease type or group, equating to the probability associated with a hospitalisation event occurring.

Equations (2) and (3) detail the calculation of the estimation of risk using the crude, or raw rate, for a given age range, A₁ to A₂, for the global region, and spatial region i, respectively.

$$\begin{matrix}r ( O ) = \frac{{\sum }_{i = 1}^{R} {c}_{i} ( O )}{{\sum }_{i = 1}^{R} {\sum }_{a = {A}_{1}}^{{A}_{2}} {N}_{ia}} & ( 2 ) \\ {r}_{i} ( O ) = \frac{{c}_{i} ( O )}{{\sum }_{a = {A}_{1}}^{{A}_{2}} {N}_{ia}} & ( 3 )\end{matrix}$$

Direct age standardisation is a smoothing technique for correcting for the variability of age distributions across areas, and is calculated using the weighted sum of the crude rate for each age group in order to combine the age group rates into a single summary statistic. The weighted sum is determined by a standard population; in this case, the standard population is determined on the fly using census data. Equations (4) and (5) detail the calculation of the direct age standardised rate, for a given age range, A₁ to A₂, for the global region, and spatial region i, respectively. Nₛₐ represents the standard population for age group a, while Nₛ is the total standard population.

$$\begin{matrix}ASR ( O ) = {\sum }_{a = {A}_{1}}^{{A}_{2}} \frac{{O}_{a}}{{N}_{a}} \times \frac{{N}_{sa}}{{N}_{s}} & ( 4 ) \\ {ASR ( O )}_{i} = {\sum }_{a = {A}_{1}}^{{A}_{2}} \frac{{O}_{ia}}{{N}_{ia}} \times \frac{{N}_{sa}}{{N}_{s}} & ( 5 )\end{matrix}$$

When reporting on rates, it is common to include a population scaling factor, thus, the rate is calculated as r(O)×S, and ASR(O)×S, in order to report the rate with respect to the scaled population, for example, a rate of 0.001 could be reported as 10 per 10, 000. Using the proposed processing approach, S can be considered an input parameter. Another common statistical summary is a ratio of rates, this equates to a comparison of the observed number of events to the expected number of events within region i. There are a number of methods that can be used to determine the rate ratio, the raw rate ratio (Equation (6)), the standardised mortality ratio (Equation (7)), which determines the expected rate with respect to reference rates over specified age ranges, and the ASR Ratio (Equation (8)), which is determined by adapting the direct ASR method, that is a weighted sum of the ratio of the observed events to expected events over age groups.

$$\begin{matrix}{RR ( O )}_{i} = {r ( O )}_{i} / r ( O ) & ( 6 ) \\ {SMR ( O )}_{i} = \frac{{O}_{i}}{{\sum }_{a = {A}_{1}}^{{A}_{2}} \frac{{O}_{as}}{{N}_{as}} \times {N}_{ia}} & ( 7 ) \\ {ASRR ( O )}_{i} = {\sum }_{a = {A}_{1}}^{{A}_{2}} \frac{{O}_{ia}}{\frac{{O}_{as}}{{N}_{as}} \times {N}_{ia}} \times \frac{{N}_{sa}}{{N}_{s}} & ( 8 )\end{matrix}$$

For each measure of the ratio, a value greater than 1 is indicative of an elevated risk in comparison with the expected risk. Mapping health data analysis on the fly can result in large variances, as such results are not pre-processed, and thus not pre-approved, and should be interpreted with caution. Consequently the variance, or confidence interval, should be associated with the analysis results in order to indicate the precision, or uncertainty associated with the estimation of the underlying risk. The confidence interval can be approximated using a Gaussian distribution, amongst other methods. The standard error for determination of confidence interval, CI, then becomes:

$$CI = ASR \pm {Z}_{\frac{o}{2}} {ASR}_{SE}$$

A 95% confidence interval yields ±1.96σ, where the variance of the ASR(O)ᵢ can be defined by Equation (9).

$$\begin{matrix}{v}_{i} = {\sum }_{a = {M}_{1}}^{{M}_{2}} {O}_{ia} {w}_{ia}^{2} & ( 9 ) \\ where {w}_{ia} = \frac{{N}_{sa}}{{N}_{ia} \times {N}_{s}} , & \end{matrix}$$

Due to the automated nature of the generation of the outputs detailed two data filters are required: a privacy filter, and a filter determining statistical reliability, according to the Australian Institute of Health and Welfare (AIHW) guidelines 2. The former is used to prevent potentially privacy sensitive information from being released, and the latter to prevent the returning and mapping of statistically unreliable results that could lead to erroneous conclusions.

Alongside the default filter conditions, a coverage parameter, Coverage, was introduced into the filters, enabling a user to choose the process coverage, representing the proportion of areas for which a value is returned. The coverage parameter is necessary due to the disparity between the population density of urban areas in comparison to rural areas. A lower coverage generally results in higher resolution information being returned, but with fewer areas reporting; typically rural areas will be omitted in this case. Where information on rural areas is required, a higher coverage value is appropriate. If the chosen coverage cannot be met, the system either automatically updates the input query, or prompts the user to choose a higher level query; in the latter case feedback can be provided suggesting alternative aggregation choices, for example, different temporal, spatial or demographic aggregation.

Statistical reliability is affected by both the underlying population, and the number of events. The AIHW guidelines specify that, in order for the standardised rate to be statistically reliable, the base population for each age range group used in the calculation of the rate must be greater than or equal to a given threshold, SR_{N}, and the number of hospitalisation events over all age groups must be greater than or equal to threshold SR_{O} in the spatial region (Oᵢ). Thus, for the ASR result within region i to be considered statistically significant, both threshold conditions have to be met.

Due to the flexible nature of the processing component, the age range grouping is necessarily determined dynamically. Thus, age aggregation groups are determined on the fly using the minimum age range aggregation given the coverage parameter, in order to maintain as high a resolution within age groups as is feasible. While the age range aggregation parameter, r, can be automatically determined, if a standard policy is in place, or comparison with previous ASR calculations is necessary, r can be specified as a parameter by the user. For the underlying population, N, the base value of r, without incorporating the coverage parameter, is determined as follows:

$${arg min}_{r ∈ ( 0 , 1 , … A )} := {\sum }_{a = j}^{j + r} {N}_{ia} \geq {SR}_{N} \begin{matrix}∀ i , j \\ i ∈ \{ 1 , 2 , … , R \} \\ j ∈ \{ 0 , r , 2 r , … , A \}\end{matrix}$$

Coverage ensures a set proportion of spatial regions comply with the filter conditions. Therefore, let f(i, r) represent the underlying population filter, where i is the spatial region and r is the age aggregation:

$$f ( i , r ) = \{ \begin{matrix}1 & {\sum }_{a = j}^{j + r} {N}_{ia} \geq {SR}_{N} \\ 0 & Otherwise\end{matrix} . \\ {∀}_{j} , where j ∈ \{ 0 , r , 2 r , … , A \}$$

Thus, r, incorporating the coverage parameter, is determined as follows:

$${arg min}_{r ∈ \{ 0 , 1 , … A \}} := \frac{{\sum }_{i = 1}^{R} f ( i , r )}{R} \geq Coverage$$

To determine the age range aggregation parameter for an age range demographic subset, the set j is as follows:

j ∈ {A₁, A₁+r, A₁+2r, . . . , A₂{

In this instance, A₁ represents the lower age range bound, and A₂ the upper age range bound. For hospitalisation events, the statistical reliability is determined using a threshold over the number of events combined over all age groups for the spatial region. Consequently, the number of events is independent of the age aggregation range. Consider function g(i) to be the event filter for determining statistical reliability, where:

$$g ( i ) = \{ \begin{matrix}1 & if {\sum }_{a = A 1}^{A 2} {O}_{ia} \geq {SR}_{O} \\ 0 & Otherwise\end{matrix} .$$

Coverage can be similarly applied to determine if there are sufficient observed events by asserting:

$$\frac{{\sum }_{i = 1}^{R} g ( i )}{R} \geq Coverage$$

Thus, if coverage is satisfied for both the underlying population and the observed events, the direct age standardised rate, for example, for spatial region i, using age aggregation range r, is determined as follows:

$${ASR ( O )}_{i , r} = \{ \begin{matrix}{ASR ( O )}_{i} & if f ( i , r ) = 1 ⋂ g ( i ) = 1 \\ undefined & Otherwise\end{matrix} .$$

That is, a value is returned if the statistical reliability conditions are satisfied, otherwise, no value is returned.

The privacy filter represents a server side approach to embedding probabilistic risk minimisation into the access and visualisation of health data, with the aim of minimising the risk of privacy intrusion occurring while maintaining the utility of the data set. Pervasive computing privacy mechanisms, including K-Anonymity, can be extended to apply to spatial privacy in health data by producing summary results, and considering the underlying population.

Thus, in the absence of further information, when reporting aggregate counts and summary statistics, there is Oᵢ/Nᵢ probability of associating an individual within spatial region i with the disease, or disease groups, encapsulated by O. Therefore, let cᵢ^{p}(O) be the application of k-anonymity to the implementation of current privacy policy adopted by a the data provider for counts between 1 and 5, when determining the count for spatial region i, where cᵢ^{p}(O) is defined as:

$${c}_{i}^{p} ( O ) = \{ \begin{matrix}{c}_{i} ( O ) & if {c}_{i} ( O ) > 5 or {c}_{i} ( O ) = 0 \\ {c}_{i} ( O ) & if {r}_{i} ( O ) \leq k ⋂ 0 < {c}_{i} ( O ) \leq 5 \\ undefined & Otherwise\end{matrix} .$$

This represents a conservative approach for low event counts, in conjunction with a low value of k. A more general approach to privacy is as follows:

$${c}_{i}^{p} ( O ) = \{ \begin{matrix}{c}_{i} ( O ) & if {r}_{i} ( O ) \leq k \\ undefined & Otherwise\end{matrix} .$$

However, this approach will suppress high rates, even for large populations. This can further be adjusted by considering privacy policy and privacy intrusion mechanisms. A large count may enable general inferences to be made concerning the population within the region, but the probability of identifying an individual is low given the number of events, 1/E, which would reduce associations that can be made, for example, through data linkage.

The Coverage condition can fail for the privacy filter if there is an insufficient underlying population, or, in the case of the statistical reliability, if there is an insufficient base population and/or an insufficient number of observed events.

There are two options for handling a failure in the coverage rate, namely the user can be informed of the Coverage failure and the incoming query can be adjusted accordingly, or the processing module can alter the query automatically, within given constraints, in order to re-aggregate the data at a lower resolution.

For the first option, the user can adjust the query, for example by adjusting the age range, disease groupings, or spatial resolution to increase the number of observed events, or the underlying population. The second option takes advantage of the hierarchical nature of both the ICD10 disease classification scheme, and the Australian Bureau of Statistics (ABS) Statistical Area (SA) geometry scheme.

The ABS reports over four different spatial resolutions, SA1 to SA4 corresponding to lowest and highest level of the hierarchy respectively, with groups of geometries within each level being encapsulated within a single geometry at a higher level. That is, there is a direct parent child relationship between SA geometry levels.

Similarly, the ICD10 disease classification scheme also categorises diseases using a hierarchy of disease type. Each ICD10 category comprises a chapter, a major code, and a minor code, specified in the form Cx.y where C corresponds to the chapter, and x and y the major and minor code respectively. For example, J11.0 corresponds to diseases of the respiratory system (J), Influenza and Influenza and pneumonia (J09-J18), Influenza with pneumonia, virus not identified (J11.0).

Leveraging the hierarchical nature of these two parameters enables the processing module to perform new queries, moving up each hierarchy, until the Coverage condition is met, or the highest level of both disease and geographic hierarchies are reached without Coverage succeeding. The latter represents the most general disease classification, the chapter, and the largest area, with both corresponding to the lowest resolution of the respective features. It will be appreciated that this could be performed in a wholly automated fashion or could be performed at least partially in accordance with user interactions, for example allowing a user to control a manner in which this is performed.

If the Coverage condition is not met at this phase, the first option is subsequently pursued. This automated approach, along with the automation of the age aggregation, necessitates the inclusion of detailed meta-data to be embedded within the result layer, specifying the methods used to generate the results of the process, and the outcomes for the spatial filters for each region.

In order to determine the efficacy of both the processing and filtering components, and the incorporation of the methods into a web GIS platform, the components were implemented within an example web GIS, using synthetic health data for testing. The web GIS implemented to test the efficacy of dynamic web mapping was extended with a number of spatial and non-spatial visualisations derived from the vector output of the processing module. The non-spatial visualisations comprise interactive visualisation generated using scalable vector graphics in the client web page, produced using the Data Driven Documents (D3) JavaScript API.

A number of aspects of the resulting system were tested, including the influence of filter parameters, and the visualisation of results, particularly concentrating on the use of multiple visualisations to provide context to the visualisations of the summary statistic.

Two data sets were required to test the generation of health count and summary statistics, a health data set and the demographic data required to determine the underlying population characteristics.

In this case, the health data set corresponded with synthetic hospitalisation data representing a year of hospitalisation events within Western Australia, while the population data was extracted from ABS data packs. The synthetic health data comprised approximately 700,000 simulated hospitalisation events, classified according to the International Classification of Disease (ICD10) categorisation codes. The data was stored as both point data, and unit record data spatially aggregated at the SA2 geometry level; that is, each unit record contained an index to the appropriate SA2 geometry.

The attributes over which querying was enabled comprised: major code, minor code, age, gender, and hospitalisation date. For rate calculations, both the “at risk” and standard populations were automatically calculated using the ABS demographic data.

The extraction of the population data resulted in records of the count by gender and age, by individual year, for the ABS SA2 level geometries and above, for the 2011 census.

Approximately 1360 queries were run in order to test both the coverage returned when incorporating statistical reliability, and the privacy filtering algorithm. The queries comprised calculating the count and ASR values for each major code in the synthetic health data set. The results are sorted from highest to lowest, subsequently extrapolated across results, for visualisation.

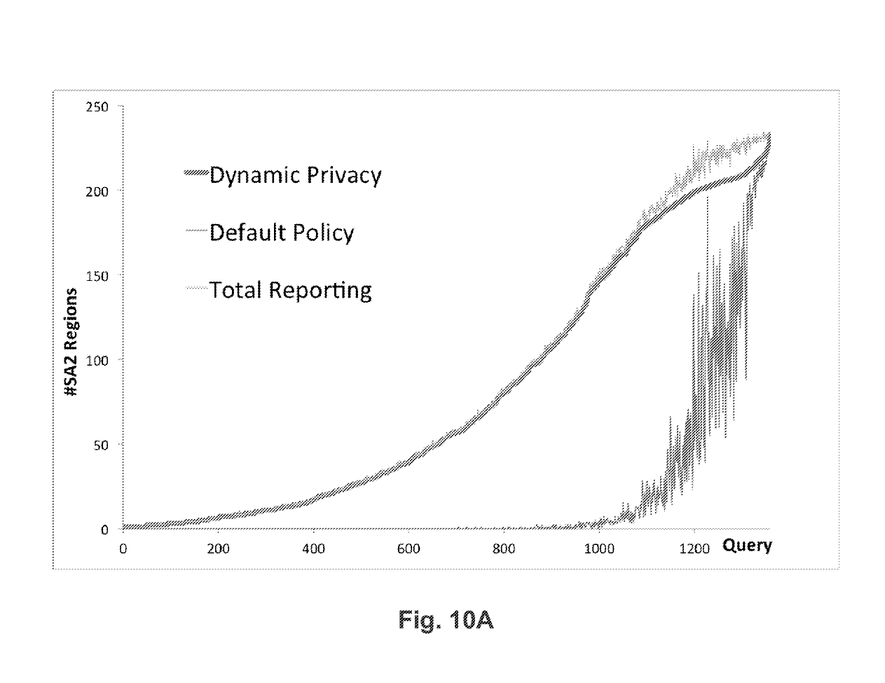

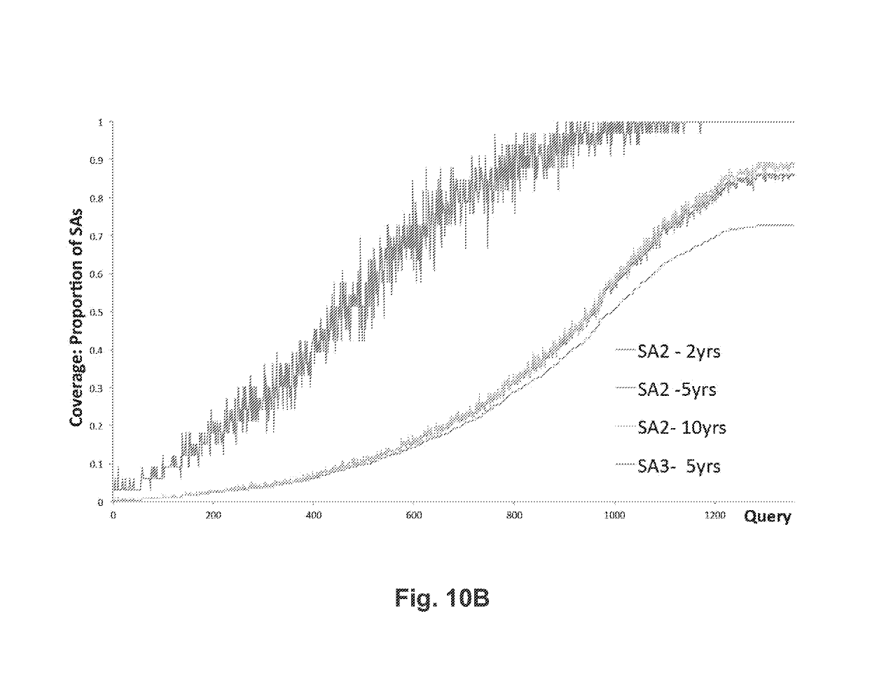

FIG. 10B shows the proportion of areas passing statistical reliability (coverage) using different age aggregations and spatial resolutions, corresponding to the ABS SA2 and SA3 for Western Australia, for the ASR. The Figure shows the increase in coverage resulting from both increasing age aggregation and decreasing spatial resolution. FIG. 10A shows the number of ABS SA2 areas passed using K-Anonymity, in comparison with a default policy of suppressing counts less than 5. There are 250 regions within the SA2 statistical geometry layer. As can be seen from the figure, K-Anonymity enables a better reporting coverage than the default privacy policy.

In terms of information access and visualisation, prevalence analysis is restricted to pre-defined census areas with known, or estimated population demographics, and thus are determined, and presented, over the census areas.

Given this constraint, there are a number of methods that can be used to access the results from the statistical summaries output by the web feature processing service (WFPS). The output of the WFPS consists of the processing results, for example the ASR and associated confidence interval, and corresponding meta-data.

Data access can be enabled through export of the results to a vector format, such as GeoJSON, or GML. Web page tables can be used as an alternative method to enable access to the data if geometries are not required. Map classification can be embedded into the table by including a Colour row, depicting the colour of the table row entry as it would appear on a thematic map. In addition to enabling access to the vector results, the statistical summary data can also be presented visually, for example in the form of a thematic map.

Thematic maps can be rendered by formatting output of the WFPS to a specified vector data output format, and passing the vector to the dynamic web map server, which can then render the virtual layer as a WMS thematic layer with the appropriate map classification colour scheme applied, and the relevant symbology attached.

To speed up access using this approach, due to the stateless nature of WMS, the virtual layer can be cached in an intermediate database, and then converted to a vector format on the fly when rendering of the virtual layer is required. Extended metadata should accompany the WFPS results to give further details on the methods used to generate the output, including references to functions and the standard population used, along with the age aggregation parameter value where applicable. This can be implemented in a metadata query response for the vector output, or by appending metadata entry in GeoJSON.

Due to the nature of certain statistical summary methods, further contextual information is required when visualising such summary data. This information is required for the interpretation of the summary result. For example, when depicting the ASR using a thematic map, a visualisation, or representation, of the uncertainty should be associated with the ASR; to aid in the interpretation, the confidence interval information can be presented simultaneously with analysis results using visualisation techniques. There are a number of methods to achieve this within a web GIS environment.

One method comprises presenting both the statistical and the contextual information using spatial visualisations. The resulting output visualisation consists of two linked slippy-maps, one with the thematic map for the statistical summary, and the other the thematic map for the confidence interval magnitude. The two maps are linked such that a change in one map triggers a similar change in the corresponding map, resulting in both maps showing the same spatial area simultaneously. This method enables the side-by-side spatial comparison of the statistical, and contextual attributes. However, in order to enable map comparisons, an Equal Intervals map classification or quantiles method should be used, which may not result in the optimal interpretation of the statistical summary.

An alternative visualisation for presentation of both the statistical summary data, and the associated contextual information, comprises using a graph presented in conjunction with a spatial visualisation, such as a scatter plot. This form of visualisation gives a detailed view of the spread of values over the ASR feature space, and enables the identification of outliers, and uncertain ASR results due to large confidence intervals. Alternatively, an error bar plot can be used.

Graph plots can be linked visually with the map visualisation by using the map classification and colour information to colour the points on the graph plots with the same colour as the corresponding spatial region. Graphs can be implemented using SVG, which enables the embedding of extra information within elements of the graph, and has the potential to include information to aid in the interpretation of the graph.

When the summary statistics for an area of the map is suppressed, for example due to privacy constraints or low statistical reliability, a number of choices can be made to reselect this information. For example, the spatial regions can be made translucent, be greyed out, or a hash pattern can all be used to inform a user that no value was returned. However, by incorporating iconography into the map layer, for example through embedding images into the thematic map, more detailed information can be conveyed to the user in conjunction with displaying the icons on a legend. This is especially relevant when more than one filter is applied during the processing phase, and meaningful icons can be used to represent multiple suppression techniques.

Accordingly, the above described arrangement provides a method for the online processing of health related or other data, incorporating issues such as statistical reliability and privacy. By processing data on the server, and enforcing appropriate privacy policies, a user is able to access analysis results while mitigating privacy risks.

As the results are generated on demand, using a dynamic query driven approach to web GIS, a statistical reliability filter is incorporated into statistical summary calculations in order to minimise the prospect of potential misinterpretation of the results. Further, visualisations combining results and uncertainty, to provide context where appropriate, can be used. As the approach is encapsulated within a web service paradigm, it can be rapidly integrated into web GIS portals.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1) Apparatus for generating a representation of data in a dataset, the apparatus including one or more processing devices that:
a) receive a search request including an indication of parameter values from a client device via a communications network;
b) generate a query using the parameter values;
c) apply the query to one or more datasets to obtain retrieved data;
d) process the retrieved data to generate results data compliant with one or more criteria;
e) generate a representation of the results data; and,
f) provide the representation of the results data to the client device via the communications network.

2) Apparatus according to claim 1, wherein the one or more processing devices:
a) compare the retrieved data to the one or more criteria; and,
b) if the one or more criteria are not satisfied, at least one of:
i) selectively process the retrieved data in accordance with the results of the comparison; and,
ii) generate a revised query to obtained alternative retrieved data.

3) Apparatus according to claim 1, wherein the one or more processing devices, process the retrieved data by filtering the retrieved data.

4) Apparatus according to claim 3, wherein the one or more processing devices progressively filter the retrieved data until the one or more criteria are satisfied.

5) Apparatus according to claim 1, wherein the one or more processing devices process the retrieved data by aggregating the data.

6) Apparatus according to claim 5, wherein the one or more processing devices process the retrieved data at least partially at least one of:
a) in accordance with user input commands;
b) using filter parameters;
c) using processing parameters; and,
d) spatially.

7) Apparatus according to claim 1, wherein the one or more criteria include privacy criteria.

8) Apparatus according to claim 1, wherein the one or more processing devices:
a) create a data store; and,
b) store the retrieved data in the data store.

9) Apparatus according to claim 1, wherein the one or more processing devices merge retrieved data at least one of:
a) from a number of datasets; and,
b) in a data store.

10) Apparatus according to claim 1, wherein the parameters include at least one of:
a) global parameters independent of the datasets, the global parameters being used in processing and presentation of the results data;
b) filter parameters related to the dataset, the filter parameters being used in filtering data to generate results data;
c) processing parameters, the processing parameters being used in processing the retrieved data; and,
d) spatial parameters, the spatial parameters being used in generating a spatial representation of the results data.

11) Apparatus according to claim 10, wherein the filter parameters include at least one of:
a) attribute parameters directly mapped to parameters of the at least one dataset;
b) virtual parameters indirectly mapped to parameters of the at least one dataset; and,
c) logical parameters that are used in controlling processing of the attribute parameters.

12) Apparatus according to claim 1, wherein the one or more processing devices:
a) determine one or more selected datasets;
b) identify parameters associated with the selected datasets; and,
c) provide an indication of available parameters to a client device via a communications network.

13) Apparatus according to claim 1, wherein the one or more processing devices:
a) provide a list of available datasets to the client device via the communications network; and,
b) receive an indication of a user selection of one or more available datasets via the communications network.

14) Apparatus according to claim 1, wherein the one or more processing devices:
a) perform a statistical analysis; and,
b) provide results of the statistical analysis with the results data.

15) Apparatus according to claim 1, wherein the representation includes at least one of:
a) a geospatial representation; and,
b) a layer for display as part of a geospatial representation.

16) Apparatus according to claim 15, wherein the representation includes:
a) a number of regions; and,
b) indicators at least partially indicative of results data associated with each region.

17) Apparatus according to claim 16, wherein the results data includes ranges of values for each region.

18) Apparatus according to claim 16, wherein the one or more processing devices process the retrieved data by aggregating retrieved data for different regions.

19) Apparatus according to claim 1, wherein the one or more processing devices:
a) provide the representation to the client device;
b) receive an indication of modified parameter values from the client device;
c) use the modified parameter values to determine a modified representation; and,
d) providing the modified representation to the client device.

20) A method for generating a representation of data in a dataset, the method including in one or more processing devices:
a) receiving a search request including an indication of parameter values from a client device via the communications network;
b) generating a query using the parameter values;
c) applying the query to one or more datasets to obtain retrieved data;
d) processing the retrieved data to generate results data compliant with one or more criteria;
e) generating a representation of the results data; and,
f) providing the representation of the results data to the client device via the communications network.
